(19) United States
(12) Patent Application Publication
(10) Pub. No.: US 2009/0198030 A1
(43) Pub. Date: Aug. 6, 2009

(54) Stable Composition for Chemical Grafting Inorganic or Organic Filler on a Polymer and Grafting Process Using Said Composition

(75) Inventors: Hervé Farge, Elancourt (FR); Jean-Claude Lapairy, Beauvais (FR)

Correspondence Address: McLELAND PATENT LAW OFFICE, P.L.L.C., 11320 RANDOM HILLS ROAD, SUITE 250, FAIRFAX, VA, 22030, US

(73) Assignee: GTI PROCESS, MERY SUR OISE (FR)

(21) Appl. No.: 12/306,159

(22) PCT Filed: Jun. 21, 2007
(86) PCT No.: PCT/FR2007/051495

§ 371 Date: Jan. 21, 2009

(30) Foreign Application Priority Data
Jun. 23, 2006 (FR) 06/05656
Aug. 2, 2006 (FR) 06/07069

(51) Int. Cl. C09K 3/00; C08F 230/04

(52) U.S. Cl. 526/240; 252/182.18

(57) ABSTRACT

The present invention relates to a stable storable composition for the chemical grafting of at least one filler comprising a hydroxyl group, onto a polymer. The composition according to the invention comprises at least one organic carboxylic acid comprising a carbon/carbon double bond that forms a resonance structure with the carbon/oxygen double bond of the carboxyl group, said composition being characterized in that it comprises a dispersing agent of the polyethylene oxide-based block polymer or copolymer type. The invention also relates to a process for chemical grafting of an organic acid onto a filler comprising at least one hydroxyl group, using said composition, so as to obtain a polymerizable liquid mixture.

The present invention relates in general to the field of curable liquid compositions for synthesising composite materials. More particularly, the aim of the invention is a stable storable composition for chemical grafting of at least one inorganic or organic filler comprising at least one hydroxyl group, on a polymer. The invention also relates to a chemical grafting process of an organic acid on an inorganic or organic filler comprising at least one hydroxyl group, using said composition, to obtain a polymerisable liquid mixture. The invention further relates to the use of said polymerisable liquid mixture especially in the presence of accelerators of metallic salts type, for various applications.

The polymers have characteristics defined and limited by their structure. The aim is thus to modify them using different techniques, inter alia by incorporation of fillers according to the final preferred characteristics. These modifications relate to for example mechanical properties, thermal resistance, fireproofing, or simply cost.

The applicant has already described in the document EP 0.233.119 a mixture for producing by chemical grafting a composition liquid, comprising an inorganic or organic filler comprising at least one hydroxyl group, an organic carboxylic acid comprising a carbon-carbon double bond in resonance with the carbon-oxygen double bond of the carboxyl group, a solvent and a given quantity of a radical catalyst which is such that said catalyst is fully consumed during reaction between the inorganic or organic filler and the organic acid, without polymerisation reaction being triggered.

However, incorporating fillers into a monomer or a polymer poses problems of dispersion due to the presence of agglomerates of filler particles which cause heterogeneities, sources of embrittlement of the polymer and poor appearance. Also, the absence of a bond between the polymer and the particles of the filler create a vacuum at the interface, causing problems of embrittlement, chalking and major sensitivity to fouling.

To eliminate these disadvantages surfactants, known as dispersants, are used to suppress the formation of agglomerates and the aim is to create a bond between the particles of the filler and the polymer, so that these particles are bound to the polymer and are no longer a cause of embrittlement, chalking and fouling.

The dispersants used are numerous and varied according to the nature of the fillers and the medium in which these fillers are dispersed. These are most often block copolymers comprising a function placed on the filler and another which remains in the matrix (monomer or polymer). The most effective are based on ethylene polyoxide (EPO).

However, the use of surfactants based on EPO has major disadvantages. In fact, the latter is a powerful complexing agent and blocks the metallic salts used for cold polymerisation of vinylic resins, in particular the polyester resins.

While carrying out work relative to studying processes of chemical grafting and compositions used by these processes, the applicant has surprisingly found that a composition comprising an organic carboxylic acid comprising a carbon-carbon double bond in resonance with the carbon-oxygen double bond of the carboxyl group and a dispersing agent based on EPO remains stable over long periods (six months) and can thus be stored for future use in chemical grafting reaction of the type described hereinabove, in the presence of a radical catalyst, resulting to obtaining a polymerisable liquid mixture. Despite the presence of a dispersing agent based on EPO, this mixture is suitable to be polymerised in the presence of accelerators based on metallic salts.

In addition, direct grafting of fillers on polymers conventionally requires the use of peroxides in a hot process. Grafting in liquid medium (solvents, reactive or not) especially makes use of the technique of condensation of silanes functionalised on the hydroxyl groups of fillers. Radical grafting of unsaturated organic acids is also known. The first technique consists of hydrolysing silane functionalised in silanol, then condensing the latter on the groups of the filler by thermal treatment to eliminate water generated by this condensation. The second technique consists of activating an unsaturated organic acid by a peroxide between 30 and 80° C. The resulting radical is fixed on the filler. Adding functionalised silane is used to create a bond between the matrix and the fibreglass for the industry of composites which utilises fibreglass. Using a dispersant and a grafting agent is thus necessary to obtain an optimal bond between the filler and the matrix.

However, the EPO mixture and silane is unstable and rapidly (in under an hour) a precipitate appears which NMR analysis of the solid detects as condensation of the silane. The latter is thus eliminated from the medium and can thus no longer fulfil its role as grafting agent. Using a dispersant based on EPO thus prohibits grafting based on silane, according to known techniques.

According to a first aspect, the aim of the invention is a stable storable composition for chemical grafting of at least one inorganic or organic filler comprising at least one hydroxyl group on a polymer, said composition comprising at least one organic carboxylic acid comprising a carbon-carbon double bond in resonance with the carbon-oxygen double bond of the carboxyl group, said composition being characterised in that it comprises a dispersing agent of block polymer or copolymer type based on ethylene polyoxide.

The composition according to the invention remains stable when it is incorporated into a resin, for example unsaturated polyester, or a solvent.

In an embodiment of the invention, the composition further comprises a alkyltrialkoxysilane (abbreviated hereinafter as silane).

According to a second aspect, the invention relates to a chemical grafting process of an organic acid on an inorganic or organic filler comprising at least one hydroxyl group, characterised in that it consists of adding to the composition of the invention an inorganic or organic filler comprising at least one hydroxyl group and a given quantity of a radical catalyst, to obtain a liquid mixture, polymerisable especially in the presence of accelerators based on metallic salts.

According to a third aspect, the invention relates to the various applications of the polymerisable liquid mixture according to the invention, specifically the production of composite materials especially having improved mechanical or fire or anti-graffiti properties.

The invention will now be described in detail.

According to a first aspect, the aim of the invention is a stable storable composition for the chemical grafting of at least one inorganic or organic filler comprising at least one hydroxyl group on a polymer, said composition comprising at least one organic carboxylic acid comprising a carbon-carbon double bond in resonance with the carbon-oxygen double bond of the carboxyl group, said composition being characterised in that it comprises a dispersing agent of the block polymer or copolymer type based on ethylene polyoxide.

This composition remains stable when it is incorporated into a resin, especially of the unsaturated polyester type, or a solvent not including a hydroxyl group; it reacts only from the moment when introduced to a filler in the preparation, in the presence of a radical catalyst, according to the grafting mechanism described in the document EP 0.233.119. In an embodiment of the invention, the composition further comprises a silane, the role of which is to improve grafting reaction.

Infrared analysis by Fourrier transforms (IRTF) of the composition according to the invention shows a modification of the bands characteristics of the EPO. The acid would be fixed by Van der Walls bonds on the EPO, thus preventing it from playing its complexing role vis-à-vis the metallic salts. This is confirmed by the fact that the vinylic resins filled and grafted by this mixture are perfectly cold-polymerisable using a metallic salt as accelerator.

The composition according to the invention lowers the viscosity of filled resins thus favouring their use. Contrary to known dispersants based on EPO, it is compatible with accelerators based on metallic salts, especially cobalt, vanadium, iron, copper, tin, thus conducting cold polymerisations.

Relative to the grafting process described in the document EP 0.233.119, the yield of the grafting of the polymer on the fillers is improved by the fact that the dispersing agent present in the composition according to the invention favours the attraction of the other constituent(s) to the hydroxyl sites present on the filler.

The organic carboxylic acid comprising a carbon-carbon double bond in resonance with the carbon-oxygen double bond of the carboxyl group, entering the composition according to the invention is preferably selected from the group of acids: maleic, itaconic, acrylic, methacrylic, cinnamic, 3-methylpent-2-enoic.

The silane entering the composition according to the invention is an alkyl tri alkoxysilane selected from the group: N-(n-Butyl-3-aminopropyl trimethoxysilane, N-(2-aminoethyl)-3-aminopropyl methyl dimethoxysilane, 3-aminopropyl methyl diethoxysilane, 3-urcido propyl triethoxysilane, hexadecyl trimethoxysilane, phenyl trimethoxysilane, phenyltriethoxysilane, 3-aminopropyl triethoxysilane, 3-aminopropyl trimethoxysilane, N-2-aminoethyl-3-aminopropyltrimethoxysilane, tridecafluoro-octyltriethoxysilane, 3-glycidyloxy-propylthoxysilane, 3-glycidyloxypropylmethoxysilane, isobutyltriethoxysilane, isobutyltrimethoxysilane, 3-methacryloxypropyl-trimethoxysilane, methyl tri ethoxysilane, 3-mercapto propyl trimethoxysilane, methyl trimethoxysilane, octyl tri ethoxysilane, octyl trimethoxysilane, propyl tri ethoxysilane, propyl trimethoxysilane, vinyl triethoxysilane, vinyl trimethoxysilane, vinyl(2-methoxyethoxy)silane.

According to a second aspect, the invention relates to a chemical grafting process of an organic acid on an inorganic or organic filler comprising at least one hydroxyl group, characterised in that it consists of adding to the composition of the invention an inorganic or organic filler comprising at least one hydroxyl group and a given quantity of a radical catalyst, which is of the type of those used for initiating a radical reaction (diazo- or peroxide), to obtain a liquid mixture, polymerisable especially in the presence of accelerators based on metallic salts.

The radical catalyst can be selected from the following peroxides: dibenzoyl peroxide, methyl ethyl ketone peroxide, cyclohexanone peroxide, acetyl acetone peroxide, peroxydicarbonate of bis(4-tertbutylcyclohexyl), dicumyl peroxide, O,O-tertiobutyl and O-2-ethylhexyl percarbonate, 2,5-Dimethyl-2,5-di(2-ethylhexanoylperoxy)hexane, tertiobutyl peroxy-2-ethylhexanoate, 1,1-di(Tert-butylperoxy)cyclohexane, cumyl hydro peroxide, 1,1-di(Tert-butylperoxy)-3,3,5 trimethylcyclohexane, tertio butyl peroxy3,5,5,trimethyl hexanoate, tertio butyl hydro peroxide, tertiobutyl peroxybenzoate, di-tert-butyl peroxide, tertio butyl and isopropyl percarbonate, methyl iso butyl ketone peroxide, tertio butyl and cumyl peroxide.

The inorganic filler is selected from the group of metallic oxides, hydroxides such as alumina tri hydrate, carbonates, silicas. The organic filler can be cellulose or another carbon hydrate.

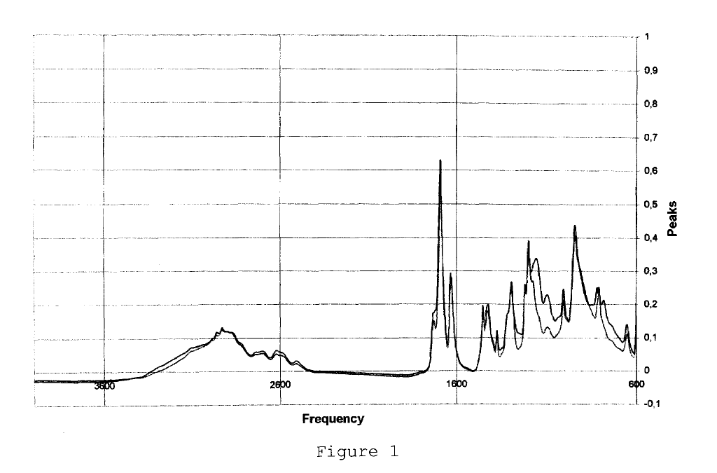

IRTF analysis of grafted silica, of the Aerosil 300 type, shows the presence of a carbonyl group (peak at 1711.25 cm⁻¹), proof that the organic acid has been grafted on the filler. The results are listed in the attached FIGS. 1 to 4, in which:

FIG. 1 illustrates the spectrum corresponding to the mixture of organic carboxylic acid and EPO;

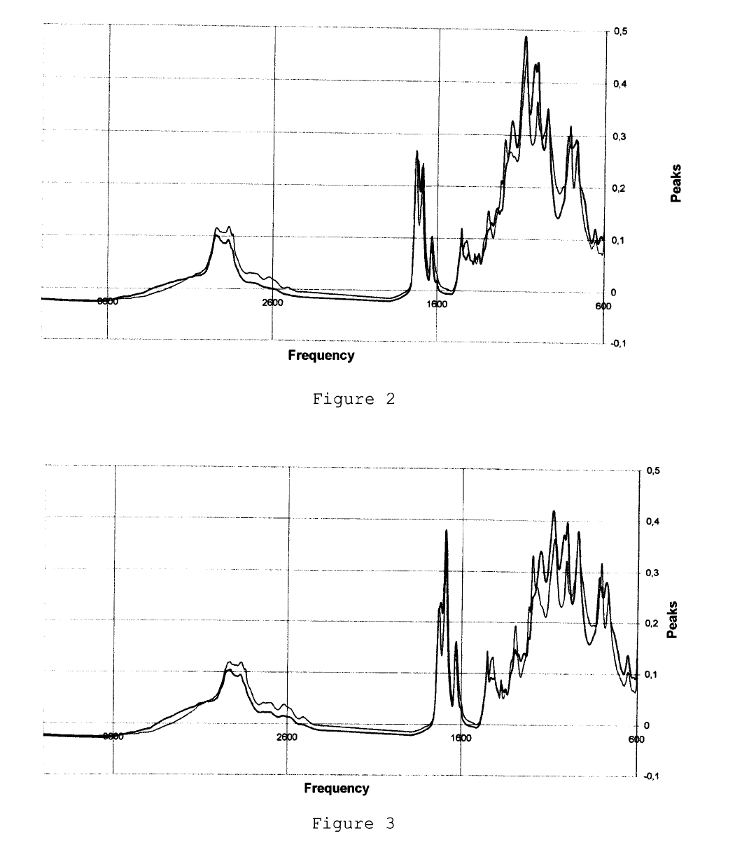

FIG. 2 illustrates the spectrum corresponding to the mixture of organic carboxylic acid, EPO and silane, present in proportions 23%/60%/17% by weight, respectively;

FIG. 3 illustrates the spectrum corresponding to the mixture of organic carboxylic acid, EPO and silane, present in proportions 37%/49%/14% by weight, respectively;

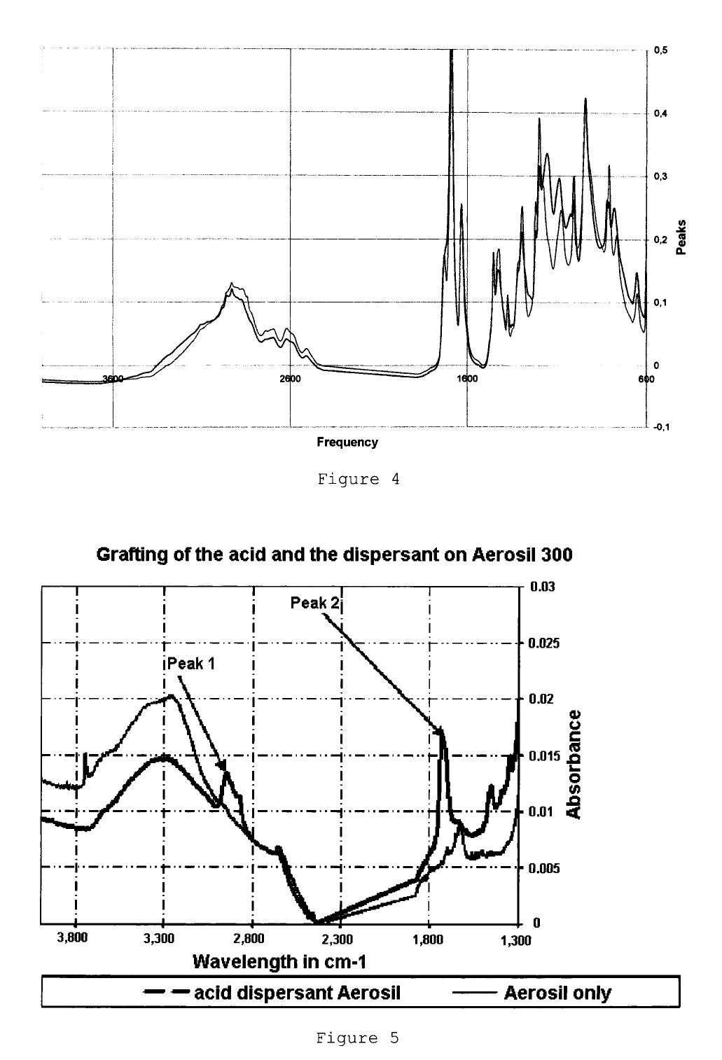

FIG. 4 illustrates the spectrum corresponding to the mixture of organic carboxylic acid, EPO and silane, present in proportions 58%/33%/9% by weight, respectively.

It is thus possible according to the invention to make a mixture of dispersant and unsaturated organic acid, optionally in the presence of functionalised silane, ready for use, to effect optimised filler grafting, as well as post grafting of the fibreglass in the composite applications. The relative proportions of the constituents of the mixture are a function of the nature of the filler to be processed.

According to a third aspect, the invention relates to the various applications of the polymerisable liquid mixture according to the invention, specifically the production of composite materials having especially improved mechanical or fire or anti-graffiti properties.

The invention will be better understood from the description of the following embodiments given by way of non limitation of the invention.

### EXAMPLE 1

### Storage Conditions of the Composition According to the Invention

The composition according to the invention, comprising a dispersant based on EPO, optionally a silane and organic acid, is stable for relatively long periods (a few months), without formation of a precipitate. After six months, a mixture comprising 40 parts of EPO, 35 parts of methacrylic acid and 15 parts of VTMO exhibits no trace of precipitate.

We have made different mixtures of a block copolymer, EPO-PCL, a silane (VTMO), and an unsaturated organic acid (AMA) according to the quantities described in the following table:

| Copolymer | VTMO | AMA |
|---|---|---|
| 8 | 2 | 0 |
| 7.5 | 1.875 | 0.625 |
| 7.2 | 1.8 | 1 |
| 7 | 1.75 | 1.25 |
| 6.8 | 1.7 | 1.5 |
| 6.6 | 1.65 | 1.75 |
| 6.4 | 1.55 | 2 |
| 6.2 | 1.5 | 2.25 |

These mixtures are packed in closed glass flasks and placed in the oven at 50° C. After 18 hours spent in the oven, the presence of traces of gel on the walls of the flask is evident in the first mixture. After 5 days in the oven, none of the other mixtures evolved. This reveals the property which acid has of blocking the condensation of the silane by complexing of the function of the EPO which catalyses the condensation. NMR analysis shows that this is condensed silane.

A mixture without acid was packed in an open cup. The formation of a surface film was noticed after 15 minutes. The mixture behaves differently according to whether it is in a closed flask or in an open cup. We formed the hypothesis that, in an open cup, the mixture could absorb the humidity in the air, causing hydrolysis of the silane, the first stage of its condensation.

0.5 g of distilled water are added to 10 grams of a mixture without acid. This mixture was packed into a stoppered flask and heated to 50° C. in the oven. No precipitate or gel appeared. It is therefore not the humidity in the air which would initiate hydrolysis of the silane. We twice placed 10 g of the mixture without acid into an open cup. In one, we added 1 g of alcohol (isobutanol). The one without alcohol had a film appearance time of 12 minutes. The one with alcohol had a time of 20 minutes. It is supposed that hydrolysis of the silane is conditioned by evaporation of methanol. This would explain why mixtures in closed flasks are stable. Recent IRTF analysis of mixtures of type 8063, dating from 2 months and 4 months, shows no sensitive evolution.

### EXAMPLE 2

### Grafting of the Organic Acid and of the Dispersant Based on EPO on the Pyrogenated Silica

Aerosil® 300 was selected due to its strong specific surface (300 m²/g) which detects the grafting of organic compounds at its surface by infrared spectrometry.

The following mixture was made up: 1 g of methacrylic acid, 0.5 g of dispersant BYK® W9010, 2.5 g of Aerosil® 300, 50 g of toluene. The whole is brought to 85° C. with stirring. 0.135 g of dibenzoyl peroxide is added at 50% (Lucidol CH50). A sharp drop in viscosity is noticed very quickly.

The mixture is left with stirring at a temperature of 85° C. for 30 minutes. The suspension is left to cool, then is centrifuged for 15 minutes. The floated liquid phase is evacuated and is replaced by pure toluene. The silica is dispersed in this toluene to complete rinsing. The operation is repeated four times to eliminate any trace of organic compound other than the toluene not fixed on the silica.

After final centrifuging, the silica is recovered and autoclaved overnight at 90° C. to eliminate all the toluene by evaporation. The result is a white powder which is then sent to the infrared spectrometer with Fourier transform as well as pure Aerosil.

As the spectra present in the attached FIG. 5 show, peaks at 1726 cm⁻¹ corresponding to a carbonyl group and 2937 cm⁻¹ corresponding to groups CH2 and CH3 appear. Radical organics have consequently been grafted at the surface of the silica.

### EXAMPLE 3

### Grafting the Organic Acid and Dispersant Based on EPO on Alumina Tri Hydrate (ATH)

Alumina tri hydrate (ATH) is conventionally added to improve the fire endurance of organic materials. This product liberates its composition water from 400° C. in consuming very strong energy coming from combustion. Chloride or bromide flame retardants are now proscribed on account of their toxicity.

In current processes, in particular in polyester resins, 50% by weight of ATH cannot be exceeded, since viscosities then become redhibitory.

To obtain improved qualities of fire performance, the experiment showed that a minimum of 74% of ATH by weight was needed, without halogens or antimony.

According to the process of the invention, the same viscosity can be obtained as a classic resin charged at 50% by incorporating 75 parts of ATH in 35 parts of resin polyester, due to grafting completed with the addition of 1.5 parts of an organic acid mixture and dispersant based on EPO, the reaction being primed by dibenzoyl peroxide.

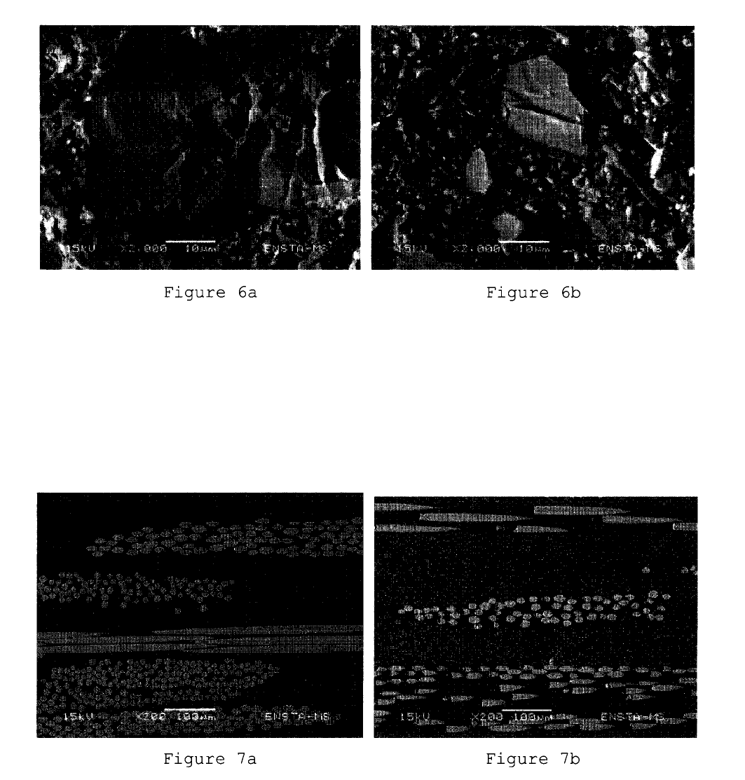

FIG. 6 illustrates scanning electronic microscope views of a fracture of charged resin polyester of ATH.

It is evident in FIG. 6a (having used the grafting process according to the invention) that the rupture is in the polyester matrix and in the filler, whereas in FIG. 6b (without grafting), the rupture appears only without the matrix, proving that there is no charged bond matrix.

### EXAMPLE 4

### Grafting the Organic Acid and Dispersant Based on EPO on Silica

Resin concretes formulated as follows are currently known: for 100 parts by weight of a mixture of silica of 3 to 250 microns, 12 parts by weight of resin polyester.

In ensuring grafting with 1.3 parts of a mixture of organic acid, dispersant based on EPO and silane, primed by dibenzoyl peroxide the quantity of resin can be lowered to 7 parts while retaining the same viscosity and the same mechanical performance once polymerised.

### EXAMPLE 5

### Grafting the Organic Acid and Dispersant Based on EPO on Aluminium

Attempts are currently being made to produce resins with high thermal conductivity while being electrically insulating for encasing the coils of motors or electric alternators and significantly boosting their cooling.

A composition is made comprising 100 parts of a mixture of aluminium powder of 4 to 21 microns and a silica of a diameter less than or equal to 1 μm dispersed in 13 parts of polyester resin and grafted by way of 1.2 parts of the organic acid mixture, dispersant based on EPO and silane, the reaction primed by dibenzoyl peroxide.

This composition is fluid enough to penetrate inside the coils. After polymerisation, the resulting product exceeds the percolation rate of aluminium grains, giving very good thermal conductivity of 3.3 W/m° K. which is at least three times greater than current products.

### EXAMPLE 6

### Grafting the Organic Acid and Dispersant Based on EPO on ATH and Fibreglass

The formulation of Example 3 is used. To this is added 1% by weight of an organic acid mixture, dispersant based on EPO and silane.

As this formulation is being carried out in impregnation by fibreglass, catalysed with peroxide and optionally accelerated by a metallic salt or an amine, the result is grafting of the matrix on the fibreglass according to the process of the invention.

FIG. 7 illustrates scanning electronic microscope views of a cut of polyester resin charged with ATH and fibreglass.

It is evident from FIG. 7a (having used the grafting process according to the invention) that fibreglass does not exhibit any rupture coming from cutting, then from polishing with diamond powder whereas in FIG. 7b (without grafting), the fibres are broken, proving that they are not bonded to the matrix.

### EXAMPLE 7

### Grafting the Organic Acid and Dispersant Based on EPO on Calcium Carbonate

BMC (Bulk Molding Compound) formulated as follows are currently known: 230 parts of calcium carbonate of 3 μm diameter (average) and 20% of cut fibreglass are added for 100 parts by weight of a resin mixture, <<low profile >> additive and various other constituents.

The same rheology is obtained by transferring the carbonate part from 230 parts to 400 parts with grafting, using 3 parts of the organic acid mixture, dispersant based on EPO and silane, the reaction being primed by dibenzoyl peroxide.

Once the BMC is polymerised, this produces at least equivalent mechanical performances and above all far superior surface appearances with no microporosity.

### EXAMPLE 8

### Grafting the Organic Acid and Dispersant Based on EPO on the Alumina Tri Hydrate (ATH) in a Multifunctional Urethane Acrylic Monomer with a View to Improving the Antigraffiti Qualities of a Flame-Retardant Gelcoat

To obtain an antigraffiti coating the surface of the material must have adequate chemical resistance, and also there must be a chemical bond between the fillers and the matrix to prevent interstices creating porosities.

French patent application No. 04 09976 filed by the applicant describes these conditions and gives examples of coating compositions.

Utilising multifunctional urethane acrylic monomers, in place of the acrylic monomer derived from bisphenol A gives the same antigraffiti qualities. Also, these monomers are more reactive and thus easier to surface-polymerise to prevent the slightest presence of a free double bond preventing it from being antigraffiti. Finally, once it is polymerised, the material has the advantage of having better UV resistance than the material based on acrylic monomer derived from bisphenol A.

1. A stable storable composition for chemical grafting of at least one filler comprising at least one hydroxyl group, on a polymer, said composition comprising at least one organic carboxylic acid comprising a carbon/carbon double bond in resonance with the carbon/oxygen double bond of the carboxyl group, said composition being characterised in that it comprises a dispersing agent of the polymer or copolymer type with block based on ethylene polyoxide.

2. The composition as claimed in claim 1, further comprising a vinylic resin.

3. The composition as claimed in claim 1, further comprising a solvent not including a hydroxyl group.

4. The composition as claimed in one of claims 1 to 3, further comprising an alkyl tri alkoxysilane.

5. The composition as claimed in one of claims 1 to 4, in which the organic carboxylic acid is selected preferably in the group of maleic, itaconic, acrylic, methacrylic, cinnamic, 3-methylpent-2-enoic acids.

6. A chemical grafting process of an organic acid on a filler comprising at least one hydroxyl group, characterised in that it consists of adding to the composition as claimed in one of claims 1 to 4 a filler and a given quantity of a radical catalyst, to obtain a polymerisable liquid mixture.

7. The process as claimed in claim 6 in which the filler is selected from the group of metallic oxides, hydroxides, carbonates, silicas, cellulose.

8. The process as claimed in one of claims 6 or 7 in which the radical catalyst is selected for example from the following peroxides: dibenzoyl peroxide, methyl ethyl ketone peroxide, cyclohexanone peroxide, acetyl acetone peroxide, peroxydicarbonate of bis(4-tertbutylcyclohexyl), dicumyl peroxide, O,O-tertiobutyl and O-2-ethylhexyl percarbonate, 2,5-Dimethyl-2,5-di(2-ethylhexanoylperoxy)hexane, tertiobutyl peroxy-2-ethylhexanoate, 1,1-di(Tert-butylperoxy)cyclohexane, cumyl hydro peroxide, 1,1-di(Tert-butylperoxy)-3,3,5-trimethylcyclohexane, tertio butyl Peroxy3,5,5,trimethyl hexanoate, tertio butyl hydro peroxide, tertiobutyl peroxybenzoate, di-tert-butyl peroxide, tertio butyl and isopropyl percarbonate, methyl iso butyl ketone peroxide, tertio butyl and cumyl peroxide.

9. Use of the polymerisable liquid mixture obtained by the process as claimed in one of claims 6 to 8, the mineral filler comprising alumina tri hydrate and fibreglass for manufacturing composite materials having improved mechanical properties.

10. Use of the polymerisable liquid mixture obtained by the process as claimed in one of claims 6 to 8, the mineral filler comprising alumina tri hydrate for manufacturing composite materials resistant to fire.

11. Use of the polymerisable liquid mixture obtained by the process as claimed in one of claims 6 to 8, said mixture comprising a multifunctional urethane acrylic monomer and the mineral filler comprising alumina tri hydrate for manufacturing composite anti-graffiti materials.

12. Use of the polymerisable liquid mixture obtained by the process as claimed in one of claims 6 to 8, the mineral filler comprising calcium carbonate for manufacturing composite materials to produce moulded items having an improved surface state.
